(19) United States
(12) Patent Application Publication
(10) Pub. No.: US 2005/0178733 A1
(43) Pub. Date: Aug. 18, 2005

(54) Sub-critical oxidative processes

(76) Inventors: Harry C. Conger, Santa Fe, NM (US); James W. Muzzy, Lakewood, CO (US); Paul J. Cornay, Longmont, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/027,824

(22) Filed: Dec. 29, 2004

Related U.S. Application Data
(60) Provisional application No. 60/533,721, filed on Dec. 30, 2003.
(60) Provisional application No. 60/604,647, filed on Aug. 25, 2004.

(51) Int. Cl. C02F 1/72; C02F 1/78

(52) U.S. Cl. 210/760; 210/759; 210/192; 210/761

(57) ABSTRACT

The invention relates to sub-critical processes and systems for accomplishing the same. In one aspect, the process is a sub-critical oxidation process for the destruction of organic and inorganic contaminates within a waste fluid or gas. The sub-critical processes are preferably carried out in a reactor and/or continuous flow centrifuge operating at sub-critical temperature and pressure. The processes and systems provide for destruction of high levels of organic and inorganic contaminates within a contaminate source, which represents a vast improvement over other conventional approaches. The processes and systems also accomplish this superior destruction of contaminates in a much faster time frame, i.e., minutes as compared to hours. Finally, the processes and systems described herein provide a safe and highly economical sub-critical approach as compared to the super-critical conditions, i.e., exceeding high temperatures and pressures, used in most conventional approaches.

### CROSS REFERENCE TO RELATED APPLICATIONS

The present non-provisional patent application is related to and claims priority of U.S. Provisional Application Ser. No. 60/604,647, filed on Aug. 25, 2004, entitled “Sub-Critical Oxidative Processes”, which is incorporated herein by reference, and of U.S. Provisional Application Ser. No. 60/533,721, filed on Dec. 30, 2003, entitled “Sub-Critical Oxidative and Hydrolytic Processes”, which is also incorporated herein by reference.

### TECHNICAL FIELD

The invention relates to sub-critical oxidative and phase separation based processes. Oxidation is carried out in a reactor and/or a continuous flow centrifuge operating at sub-critical temperature and pressure.

### BACKGROUND OF THE INVENTION

The ability to treat organic and inorganic waste materials from industrial and municipal sources is a persistent and growing problem in the industrialized world. Several oxidative techniques have been developed for the destruction of these organic and inorganic materials, several of which are discussed in greater detail below. Note that all such techniques have been inefficient at treating sources with higher concentrations of contaminates, i.e., greater than 100 mg/L, and in timely fashions, i.e., less than within a one to three hour time frame.

U.S. Pat. No. 6,093,328 discloses the use of hydrogen peroxide and solid particles formed between elemental iron and sulfur to remove arsenic and total organic carbon from water. The reaction is carried out at or below 100° C.

U.S. Pat. No. 5,928,522 discloses a process for treating oil refining waste. After the removal of large particles and waxy material, the remaining liquid is drawn off and centrifuged. The residual cake is treated with hydrogen peroxide and water to form a slurry which is heated to 100° F.

U.S. Pat. No. 6,251,290 discloses the use of hydrogen peroxide in a limited Fenton reaction to treat hydrocarbon ore at 60° C. to 100° C. This results in the partial oxidation of the hydrocarbons.

Oxidants such as hydrogen peroxide (H₂O₂) have been used in a number of applications to treat fluids containing various waste materials. U.S. Pat. No. 6,051,145 and related U.S. Pat. No. 5,888,389 each disclose a multi-stage treatment of sewage sludge. The first stage uses a sub-critical temperature between approximately 100° C. and 357° C. and a super-critical pressure between about 3,600 psi to 4,500 psi. The oxidant may be air, oxygen or hydrogen peroxide. The second stage is run at a higher temperature so as to produce super critical oxidation conditions. Neither the first nor second stages utilize a centrifuge to produce the required temperatures and pressures.

U.S. Pat. No. 5,240,619 discloses a process characteristics of a super-critical oxidation process This process utilizes oxygen containing gas and pressures well in excess of the super critical pressure, e.g., 350 atm. The super-critical pressure is applied in a first stage reaction at a temperature between 250° C. and 374° C. The second stage reaction is carried out at the same pressure and a temperature between 374° C. and 600° C. This results in super critical oxidation conditions in the second stage reaction.

U.S. Pat. No. 6,080,309 discloses a process for the separation of impurities from liquids. In this process, a centrifuge is used to achieve temperatures and pressures which are no lower than 705.4° F. (374.1° C.) and 3,208 pounds per square inch. Such conditions exceed the super critical pressure and temperature of water. After reaching super critical conditions, oxygen in any form is introduced into the suspension. An oxidizing reagent such as H₂O₂ may be used.

Against this backdrop the present invention has been developed.

### SUMMARY OF THE INVENTION

There is not one reaction or design that through oxidation destruction of contaminates solve every waste water contamination problem. The selection of chemicals and process design for the oxidation of contaminates must be based on the specific waste water characteristics. With that in consideration, the following preferred embodiments are provided.

Note that the processes and compositions of the present invention are useful in the destruction, i.e., partial to complete oxidation, of high levels of organic and non-organic contaminates, i.e., up to 3,000+mg/L, which represents a vast improvement over other conventional approaches to these same problems. In addition, the processes and compositions of the present invention provide a safer and more economic approach to destruction of these same contaminates over other conventional approaches.

In one aspect, the invention is directed to a process for oxidizing organic and inorganic contaminates in waste fluids with hydroxyl radicals using sub-critical temperature and pressure. The waste fluid contains dissolved contaminates, solutes, gaseous effluents, dissolved volatile gases and/or suspended solids which are oxidizable under sub-critical temperature and pressure. Such waste material includes industrial wastes such as those produced by oil and gas industries, chemical industries and mining industries. Other waste materials include, but are not limited to, agricultural waste, sewage waste and dredging sludge.

The waste fluid is contacted with an oxidizing reagent such as hydrogen peroxide and subjected to sub-critical temperature and pressure to oxidize all or part of the waste material. The sub-critical temperature is between ambient temperature and a temperature less than 374.1° C., more preferably between ambient temperature and 300° C., still more preferably between ambient temperature and 260° C., and most preferably between ambient and between 100° C. The sub-critical pressure is between about 1 atmosphere and a pressure less than 3208 psi, preferably between 1 atmosphere and 1500 psi, and more preferably between 1 atmosphere and 500 psi, and most preferably between about 1 atmosphere and 200 psi.

In another embodiment of the present invention, the waste fluid is contacted with an oxidizing reagent such as hydroxyl radicals and subjected to low temperatures and pressures to oxidize all or part of the waste material. The temperature is between about ambient temperature and a temperature less than about 200° C., more preferably between ambient temperature and a temperature less than 100° C., and the pressure is between about 1 atmosphere and a pressure less than about 200 psi.

Processes of the present invention may be carried out in a reactor or within a centrifuge, or in system that includes both a reactor and centrifuge (see below for greater detail).

In one aspect of the invention, the process is carried out under conditions that produce and favor uniform hydroxyl radical formation within a waste fluid. The hydroxyl radical formed under these conditions then oxidizing contaminates within the waste fluid (note that oxidation processes of the present invention are effective at oxidizing contaminates present at up to and exceeding 3,000 mg/L). In one preferred embodiment, hydroxyl radicals are formed by combining the waste fluid with hydrogen peroxide. The mixture is then mixed with Fenton's reagent, ozone and/or other reagents that induce hydroxyl radical formation, for example titanium dioxide. The mixture may also be exposed to UV radiation to transform hydrogen peroxide to hydroxyl radicals. In all situations, the formed hydroxyl radical then oxidizes contaminates within the waste fluid.

In another embodiment, the reaction between the hydroxyl radical and contaminates (organic or inorganic) within the waste fluid is enhanced by performing the reaction using a mixing device that provides mass transfer through mixing (diffusion) of the waste mixture (containing hydrogen peroxide) with the reagent which converts hydrogen peroxide to hydroxyl radical and the use of plug flow or thin film flow increases the mass transfer of the reactor of the hydroxyl radical with contaminates. Hydroxyl radical formation may also be accomplished in a centrifuge, as discussed for sub-critical oxidation, or in a combination of a mixing device followed by in a centrifuge or reaction vessel.

Preferred temperature, pH and pressure conditions for hydroxyl radical formation within the waste fluid are similar to the conditions described above. However, the preferred temperature is between about ambient temperature and a temperature less than about 200° C., more preferably between ambient temperature and 100° C., and the pressure is between about 1 atmosphere and a pressure less than about 200 psi. When one of the reactants used in the hydroxyl radical formation is the Fenton reagent, ferric hydroxide is formed in addition to the hydroxyl radical by oxidation with Fe⁺²; addition of an acid such as a mineral acid may be needed to maintain an acidic pH, preferably at a pH between about 3 and about 5. When one of the reactants used in the hydroxyl radical formation is ozone, the pH is preferably between about 8 and about 10, and when the reactant used to form hydroxyl radical is UV, the pH is preferably between about 6 and about 9.

A mixing device for combining the waste fluid and hydrogen peroxide (H₂O₂) with a reagent such as ozone, or other like gaseous material(s), is a device capable of intimately mixing a waste fluid containing H₂O₂ with ozone gas passing through the fluid. For example, the device described in Applied Porous Technology incorporates a sintered porous metal media plate that can be integrated into a mixing device. Typically, the media plate would be positioned at either the top of the mixing device or as a plate at the bottom end of the mass transfer reactor. Ozone or other gas would then be passed through the plate and into the combined waste fluid and H₂O₂ mixture. Any number and size of ozone gas bubbles can be used, although smaller more uniform bubbles are preferred as they maximize dissolution of the ozone with the liquid environment.

Another mixing devices that maximize association between the waste fluid and hydrogen peroxide with reagents that enhance hydroxyl radical formation are those disclosed in U.S. Pat. Nos. 5,200,094, 5,344,573, and 5,403,494 (see reference numeral 16). A modified version of the device is disclosed in U.S. Pat. No. 6,361,925. Each of these references is incorporated by reference in their entirety. These preferred mixing devices can be used or modified to significantly increase the reaction rate of hydroxyl radical formation in the waste fluid and thereby oxidation of organics and inorganics within the waste fluid.

Another intimate mixing device for higher rate of hydroxyl radical formation and oxidation of contaminates is a fogging device using a swirl jet nozzle, such as the device used in the gas turbine arena, available via Fern Engineering or American Moistening Company (AMCO) (one such swirl jet nozzle device that may be suitable for the present application is shown by AMCO, Pineville, N.C., 28134). The fogging device can be used or modified to significantly increase the rate of hydroxyl radical formation in the flue gas and thereby oxidation of organics and inorganics within the flue gas. Note that these embodiments are particularly effective when the waste fluid source is a flue gas, for example from an electrical power generation plant (SO₂, NOₓ, and other gaseous phase contaminates).

A reactor can be equipped with one or more UV light source(s) to produce hydroxyl radical in a waste fluid when combined with hydrogen peroxide or other like oxidizing agent. UV light source(s) can be positioned directly within the waste fluid stream such as by placing a tubular UV light in the center of the waste fluid stream (see FIG. 10, for example).

Preferred embodiments of the invention also include reactions between hydroxyl radical and contaminates in a waste fluid in a reactor adapted to enhance mass transfer of a gas phase reactant into a liquid phase. These reactors are termed “mass transfer reactors” for purposes of the present invention, and they provide enhanced mass transfer of the reactants. Mass transfer reactors of the present invention maximizes mass transfer of a hydroxyl radical forming reagent, preferably ozone, into a waste fluid, and preferably into a waste fluid containing hydrogen peroxide. Several different waste fluid flow designs are used in the present invention to enhance and increase in mass transfer through plug flow design where movement of the fluid is as a unit having limited shear, or thin film flow where movement of the fluid maximizes turbulent flow, and therefore diffused mixing, each in association with an input gas phase hydroxyl radical forming reagent. Enhanced hydroxyl radical formed within the waste fluid then oxidizes contaminates within the waste fluid. Preferred mass transfer reactors can oxidize and destroy contaminates that are present at high levels, e.g., up to 3000 mg/L.

Preferred mass transfer processes and reactors are adapted to increase the rate of gas transfer into a waste fluid and decrease the rate of ozone and VOC contaminates out of the liquid phase, thereby maximizing the effective level of hydroxyl radical forming agent in the waste fluid. Mass transfer reactors are operated to create dissolution of ozone or similar gasses, formation of hydroxyl radicals and oxidation contact with contaminates. The reactor also operates to create minimally sized gas bubbles into units of waste fluid, for example, into plug flow units of waste fluid. Reactors, thereby, enhance the rate by which the hydroxyl radical forming reagent is transferred into the waste fluid, and therefore into contact with organic and non-organic contaminates within the waste fluid.

Mass transfer reactors and processes are preferably operated under pressures between about 1 atm and about 200 psi to ensure that the transferred hydroxyl radical forming reagent is maintained as a small bubble within the waste fluid for a maximal amount of time, therefore creating a fast and uniform reaction producing the hydroxyl radical limiting the escape or exit of the gas from the waste fluid (as well as volatile organic contaminates). Note that temperature and pH limitations are similar to those described for other hydroxyl radical forming processes of the present invention.

One preferred mass transfer reactor comprises structures that facilitate either plug flow of the waste fluid, or thin film flow of the waste fluid, in relation to input ozone bubbles.

In another aspect of the invention, the processes discussed above may be carried out in a centrifuge such as a bowl centrifuge or other continuous flow centrifuge. One embodiment of a continuous flow centrifuge is a decanter centrifuge such as a multi-phase centrifuge having a long detention time (up to a minute or more detention) (see for example, Pieralisi Benelux B.V. Decanter Centrifuge Brochure, 2003).

When using a continuous flow centrifuge, an oxidizing reagent such as hydrogen peroxide is added to the waste fluid prior to transport to an oxidation region within the centrifuge where ozone or Fenton reagent is introduced. In this continuous flow centrifuge system, the waste fluid flows through one or more channels in the centrifuge and the treated waste fluid exits by one or more channels out of the centrifuge. During transit the waste material in the waste fluid, including suspended solids, if present, are oxidized under sub-critical oxidation conditions. The oxidation region is that portion of the interior of the centrifuge defined by the region wherein sub-critical temperature and pressure exists.

Sub-critical pressure is produced by operating the centrifuge at sufficient rpm to generate a sub-critical pressure between about 1 atmosphere and a pressure less than 3208 psi (note also that sufficient pressure may also be generated via a pump). If needed, the centrifuge may also contain heating and/or cooling elements to raise and/maintain the temperature at above about ambient temperature but less than 374° C. These parameters broadly define sub-critical oxidation conditions. Unoxidized solids, partially oxidized solids produced during oxidation, or completely oxidized solids produced during oxidation are settled by centrifugal g forces. The residual solid may be removed from the centrifuge, for example via a channel. This channel may be augmented with an auger or other like device to facilitate export of the solid residue portion. Accordingly, the continuous flow oxidation process produces a treated waste fluid and in some embodiments a residual solid which is separated from other liquids.

In an alternative aspect of the invention, a continuous flow centrifuge is used in combination with a reactor in a closed system. This system is referred to as a continuous flow centrifuge/reaction vessel system. Such a system includes at least a continuous flow centrifuge for sub-critical oxidation and/or a reaction vessel for sub-critical oxidation, appropriate valves and pumps to move waste fluid through the system and to produce sub-critical pressure within the system. A pressure control valve is positioned upstream of the exhaust port for liquid disposal and carbon dioxide or other gas venting. A pressure control valve is also positioned downstream from the centrifuge and upstream from the solid residue exhaust port to maintain the pressure in the system. This pressure is preferably high enough to keep gaseous oxidation products such as carbon dioxide dissolved in the solution.

The continuous flow centrifuge/reactor system may be operated in several ways. In a first embodiment, the continuous flow centrifuge is used without fluidly engaging the reactor. In this embodiment, the sub-critical oxidation conditions are established within the centrifuge.

In another aspect of the invention, the centrifuge is fluidly engaged with the reactor by opening or closing the appropriate valves. The waste fluid is pumped into the reactor where sub-critical oxidation occurs. The fluid may also be recirculated into the reactor. Thereafter, the pretreated waste fluid flows into the continuous flow centrifuge where it is exposed to increased pressure due to the increased g forces generated in the centrifuge. The effluent from the centrifuge may be returned to the reaction vessel for further sub-critical oxidation or exit the system. Alternatively, the waste fluid may be cycled through the centrifuge for sub-critical oxidation and thereafter into the reactor for subsequent sub-critical oxidation.

In another aspect of the invention, the oxidative process is carried out in a reactor alone, without the need for a continuous flow centrifuge. This embodiment is preferred when a waste fluid has little or no solid (either present at time of treatment or that results from treatment) or liquid phase separation.

In an additional aspects of the invention, the residual solid which may be produced in the process carried out in the continuous flow centrifuge system or the continuous flow centrifuge/reaction vessel system can be further treated but not limited to super-critical oxidation. An illustrative secondary procedure is that set forth in U.S. Patent Publication 2002-0032111 A1. The treatment of the waste fluid utilizing the methods and/or systems of the invention therefore minimizes the overall amount of residual solid which may remain for super-critical oxidation.

In yet another aspect of the invention, the oxidative process comprises three oxidation steps including sub-critical oxidation before or after, sub-critical oxidation in a continuous flow centrifuge followed by further treatment, including but not limited to, staged reactors of residual solids. The purpose of carrying out two or three oxidation steps is to treat and eliminate waste material at each step thereby limiting the amount of waste material used in a subsequent oxidation step. Such an approach provides use of energy and oxidation reagents for the overall waste treatment process.

In another aspect of the invention, the process comprises hydrolyzing a waste fluid by exposing it to sub-critical temperature between about ambient temperature and a temperature less than 374.1° C. and a sub-critical pressure between about 1 atmosphere and a pressure less than 3208 psi. The process is preferably carried out in a reaction vessel or continuous flow centrifuge system, or continuous flow centrifuge/reaction vessel system as described above. Under these conditions, certain constituents of the waste fluid are hydrolyzed by water. In some embodiments a chemical reactant is added to facilitate hydrolysis. For example, calcium oxide may be added to hydrolyze phosphorus contained within the waste fluid. Such chemical reactants can be added in a manner similar to the addition of oxidant as described above. The hydrolysis process may be practiced in combination with any of the aforementioned sub-critical oxidation embodiments. This may include pretreatment of the waste fluid prior to sub-critical oxidation or sub-critical oxidation followed by post-treatment. Alternatively, hydrolysis may be carried out separately or with sub-critical oxidation.

In some embodiments one or more conditions are combined to maximize hydroxyl radical formation in the waste fluid. For example, waste fluid can be combined with H₂O₂ combined with Fenton's reagent or with ozone gas mixed in the fluid or UV light.

These and various other features and advantages of the invention will be apparent from a reading of the following detailed description and a review of the appended claims.

### BRIEF DESCRIPTION OF THE DRAWINGS

FIG. 1 is a flow diagram for sub-critical oxidation of a waste fluid in a continuous flow centrifuge system.

FIG. 2 is a flow diagram for sub-critical oxidation stages for treating a waste fluid in a reaction vessel and a continuous flow centrifuge.

FIG. 3 is a flow diagram for sub-critical oxidation of waste fluid in an alternative continuous flow centrifuge/reaction system.

FIG. 4 is a schematic of a system for sub-critical oxidation of waste fluid having a reaction vessel and optionally a continuous flow centrifuge.

FIG. 5 is a cross sections illustrative of one example of a continuous flow centrifuge.

FIG. 6. is a flow diagram for sub-critical oxidation of a waste fluid in a reaction vessel.

FIG. 7 is an illustrative schematic for an intimate mixing device in accordance with the present invention.

FIG. 8 is an illustrative cross-sectional view of a mass transfer reactor in accordance with one embodiment of the present invention.

FIG. 9 is an illustrative cross-section view of a UV light insert for inclusion within a reactor in accordance with one or more embodiments of the present invention.

FIG. 10 is a spectral diagram of waste fluid showing contaminate levels as measured by gas chromatography prior to oxidation using processes of the present invention.

FIG. 11 is a spectral diagram of the treated waste fluid showing contaminates present in the waste fluid after undergoing hydroxyl radical based oxidation as measured by gas chromatography in accordance with the present invention.

FIG. 12 is an illustrative plot showing acetone levels over the course of a sub-critical oxidation in accordance with the present invention

FIG. 13 is an illustrative plot showing acetonitrile levels over the course of a sub-critical oxidation in accordance with the present invention.

### DETAILED DESCRIPTION OF THE INVENTION

The sub-critical oxidation process of the invention is designed, but not limited, to treating waste materials from industrial and municipal sources. In addition, embodiments of the present invention are at least partially designed for the remediation of these same waste materials. As used herein, industrial waste includes: (1) waste from gas and oil related processing, including waste pits, drilling muds and refinery wastes; (2) waste from the chemical industry, including organic and petrochemical wastes; (3) waste from other industrial sources, such as waste metal, waste paints, waste solvents and waste pulp and paper; (4) waste from mining operations, (5) flue gas contaminates, for example from electrical power generation, and (6) waste from dredging operations of harbors, channels and rivers. Waste material also includes municipal sewage, waste from coal processes, and waste from agricultural sources. A waste fluid can be a liquid waste material or a fluid containing waste material. In many instances, the waste fluid will contain suspended solids.

The processes and compositions of the present invention are useful in the destruction, i.e., partial to complete oxidation, of high levels of organic and non-organic contaminates, i.e., up to 3,000+mg/L (conventional technologies are only effective at oxidizing contaminates at levels of about 1-100 mg/L). The contaminates can be in solution or as suspended solids. The processes and compositions of the invention are also extremely effective in short time frames not available in other conventional oxidation-based technologies, i.e., complete oxidation of contaminates in minutes not hours.

Many waste fluids contain organic contaminants. Components of organic compounds which can be oxidized under sub-critical conditions include, but are not limited to, sulfides, disulfides, sulfites, mercaptans, mercaptans (thio), polysulfide, phenols, benzenes, substituted phenols, alcohols/glycols, aldehydes, ethylmercaptans, ethylene, oils, fats and grease.

Typically incomplete (less than 99+%), but still useful, sub-critical oxidation reactions are:
Organics+O₂→CO₂+H₂O+RCOOH2
Sulfur Species+O₂→SO₄⁻²
Organic Cl+O₂→Cl⁻¹+CO₂+RCOOH
Organic Cl+O₂→Cl⁻¹+CO₂+RCOOH
Organic N+O₂→NH₄⁺¹+CO₂+RCOOH
Phosphorus+O₂→PO₄⁻³+CO₂+RCOOH

Where R is generally a short chain organic acid such as acetic acid which can be destroyed by biodigesters.

An illustrative complete oxidation includes but is not limited to:
Organics+OH+H₂O₂→CO₂+H₂O

As used herein, sub-critical temperature refers to a temperature between ambient temperature and a temperature less than 374.1° C. The sub-critical temperatures is preferably between ambient temperature and 300° C., more preferably between ambient temperature and about 260° C., and most preferably between ambient temperature and about 100° C. In some preferred embodiments the temperature is between ambient temperature and 50° C. and is most preferably between ambient and about 30° C. Note that for purposes of the present invention, ambient temperature is typically between about 20° C. and about 30° C., although it is noted that an ambient temperature is the temperature of the environment or room that exists in accordance with the present invention.

As used herein, a sub-critical pressure refers to a pressure between about 1 atmosphere and a pressure of less than 3208 psi. Preferably, the pressure is between 1 atmosphere and 1500 psi, more preferably between about 1 atmosphere and about 500 psi, and most preferably between 1 atmosphere and 200 psi. Sub-critical oxidation occurs when a waste fluid is simultaneously exposed to sub-critical temperature and sub-critical pressure.

Although sub-critical oxidation can be carried out batch-wise, it is preferred for purposes of the present invention to use a continuous sub-critical oxidation process or processes. A number of different embodiments of the present invention are provided, including performing the processes of the present invention in a mass transfer reactor, in a mixing vessel or in a continuous flow centrifuge. Systems that describe different embodiments of the present invention are also provided.

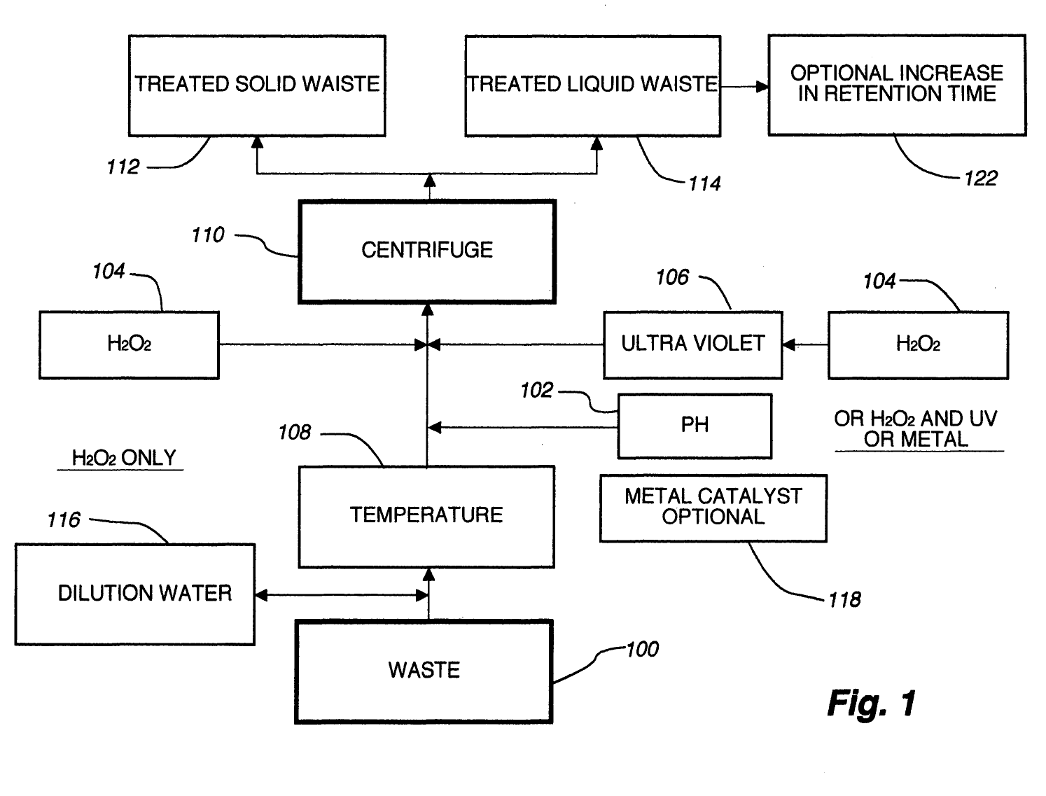

FIG. 1 is a flow diagram of a continuous flow centrifuge system for sub-critical oxidation of a waste fluid. Waste fluid 100 is processed to remove solids resulting in a waste fluid with total suspended solids in a range that results in at least 80% removal of suspended solids, more preferably at least 90% removal of suspended solids and most preferably 99+% removal of suspended solids. The pH 102 is adjusted if necessary to between 3 and 10 dependent on the reaction conditions. For example, preferred pH conditions for use of the Fenton reagent is about 3 to about 5, for ozone it is about 8 to about 10, and for UV it is about 6 to about 9. Thereafter, an oxidizing agent such as hydrogen peroxide 104 is added to the waste fluid and mixed. In an alternate embodiment, hydrogen peroxide may be added to the waste fluid, which is then treated with ultraviolet light 106 sufficient to produce free hydroxyl radicals within the waste fluid (see below for greater detail). The hydroxyl radicals then oxidize contaminates within the waste fluid. Ozone may also be used as an oxidant and in some embodiments oxygen may be used.

After being mixed with an appropriate oxidant, waste fluid temperature increases to a sub-critical temperature due to the heat produced in the oxidation produced upon mixing. The temperature may also be modified to keep it within optical sub-critical ranges, see box 108. The fluid may then flow to a continuous flow centrifuge 110. The centrifuge operates at sufficient rpm to create a sub-critical pressure. An oxidation region within the centrifuge is defined by that portion of the interior of the centrifuge which has a pressure above the minimum sub-critical pressure but less than a super-critical pressure. The temperature may be adjusted to maintain it within the range of sub-critical temperature. The sub-critical oxidation occurs within this oxidation region during the continuous flow of the waste fluid into the centrifuge and the continuous flow of the treated waste fluid exiting the centrifuge. Solids which have not been oxidized or which may form during the oxidation process are precipitated in the liquid flow area of the centrifuge 112. During this process, treated solid waste is separated from treated liquid waste 114. Dilution water 116 may be added to facilitate the reaction, as can be a metal catalyst 118. Retention time within the centrifuge can be modified to facilitate maximal oxidation, see box 120.

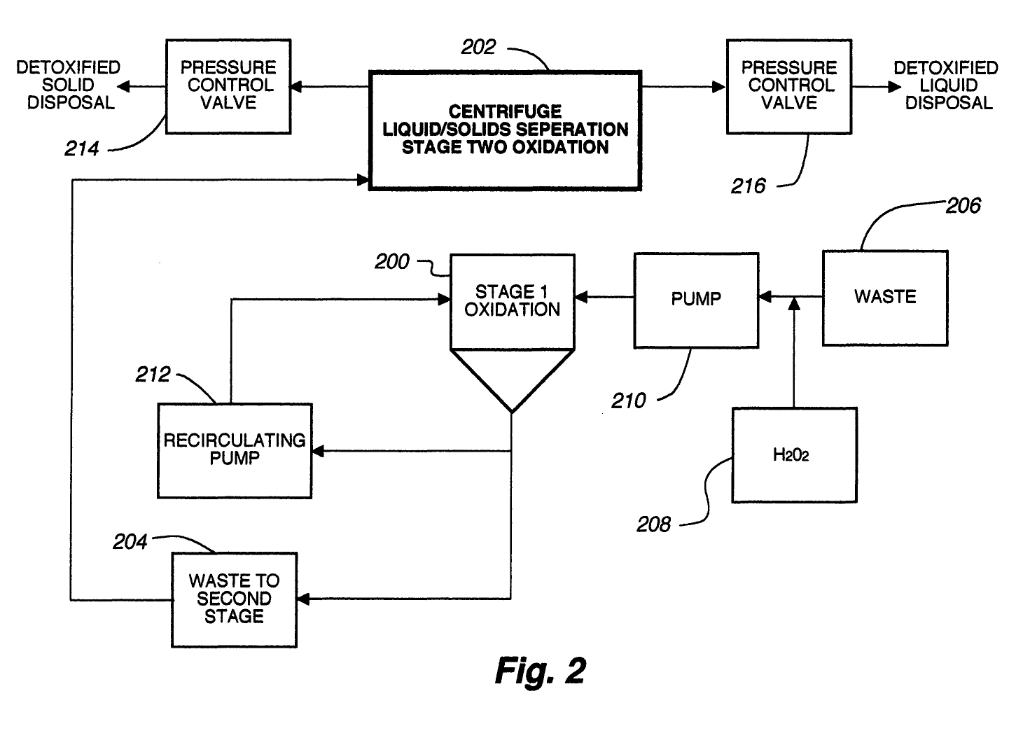

In an alternative embodiment, the waste fluid is pretreated prior to sub-critical oxidation. FIG. 2 discloses a continuous flow centrifuge/reaction vessel system for sub-critical oxidation. Stage 1 sub-critical oxidation 200 is carried out in a reaction vessel prior to stage 2 sub-critical oxidation within the continuous flow centrifuge 202. The reaction vessel is in series and fluidly connected with the centrifuge shown by waste to second stage 204, within FIG. 2. In this embodiment, waste fluid 206 is mixed with an oxidizing reagent such as H₂O₂ 208 and sub-critically oxidized in the stage 1 reaction vessel 200 (Pumps 210 facilitates this mixing and pressure). A recirculating loop may be used in this stage 1 to provide for a continuous stage 1 sub-critical oxidation reaction 212. Such pretreated waste fluid is then transferred to the second stage station comprising the continuous flow centrifuge 202 where sub-critical oxidation continues, albeit at a higher pressure in the centrifuge, in this case within the centrifuge. The continuous flow centrifuge separates oxidized and detoxified solid 214 from oxidized and detoxified liquid 216. A gas vent is included to allow for the release of product gases such as CO₂. Pressure control valves maintain the pressure in the system and a pump is provided to move waste fluid and pressurize the system.

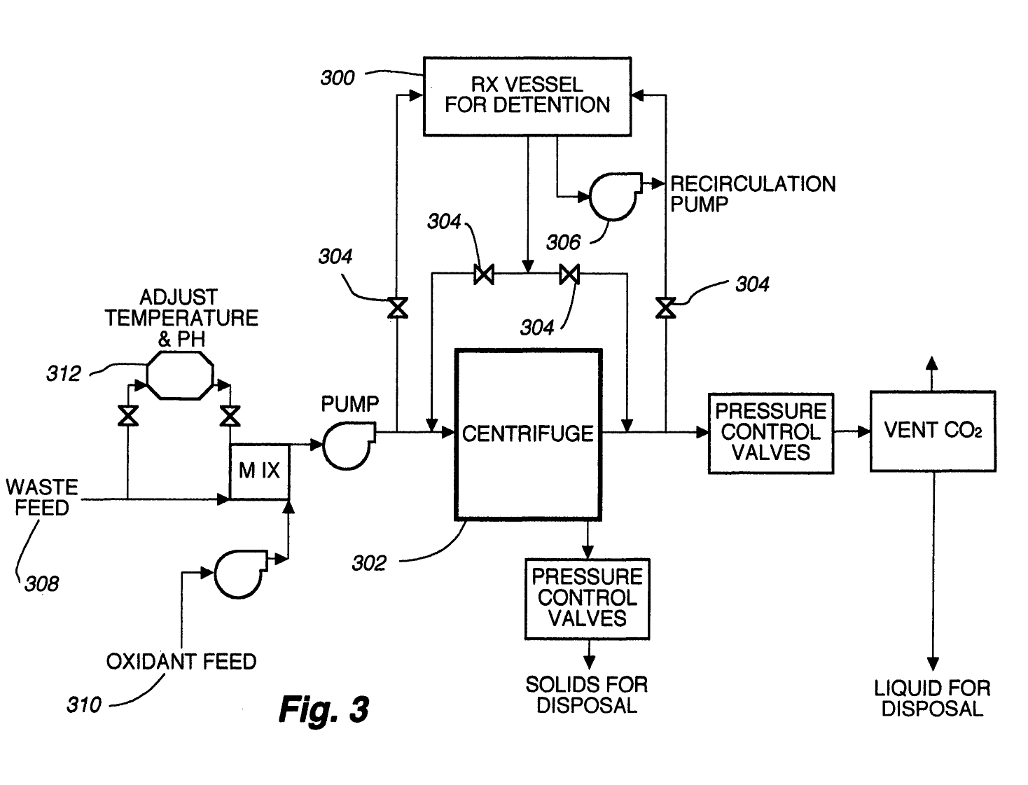

FIG. 3 discloses an alternative continuous flow centrifuge/reaction vessel system. In this embodiment, a reaction vessel 300 is used for sub-critical oxidation. Such sub-critical oxidation within the reaction vessel may occur prior to or subsequent to sub-critical oxidation within the centrifuge 302. Appropriate valves 304 are opened or closed to place the reaction vessel upstream or downstream from the continuous flow centrifuge. A pump 306 facilitates this movement. A waste feed 308, an oxidant feed 310, and a pH and temperature adjuster 312 are shown. A mixing vessel 314 is shown for combining the waste stream and oxidant feed, which can be modified with respect to pH and temperature. Also shown is a pressure control valve for modifying pressure within the system 316, including a CO₂ vent 318.

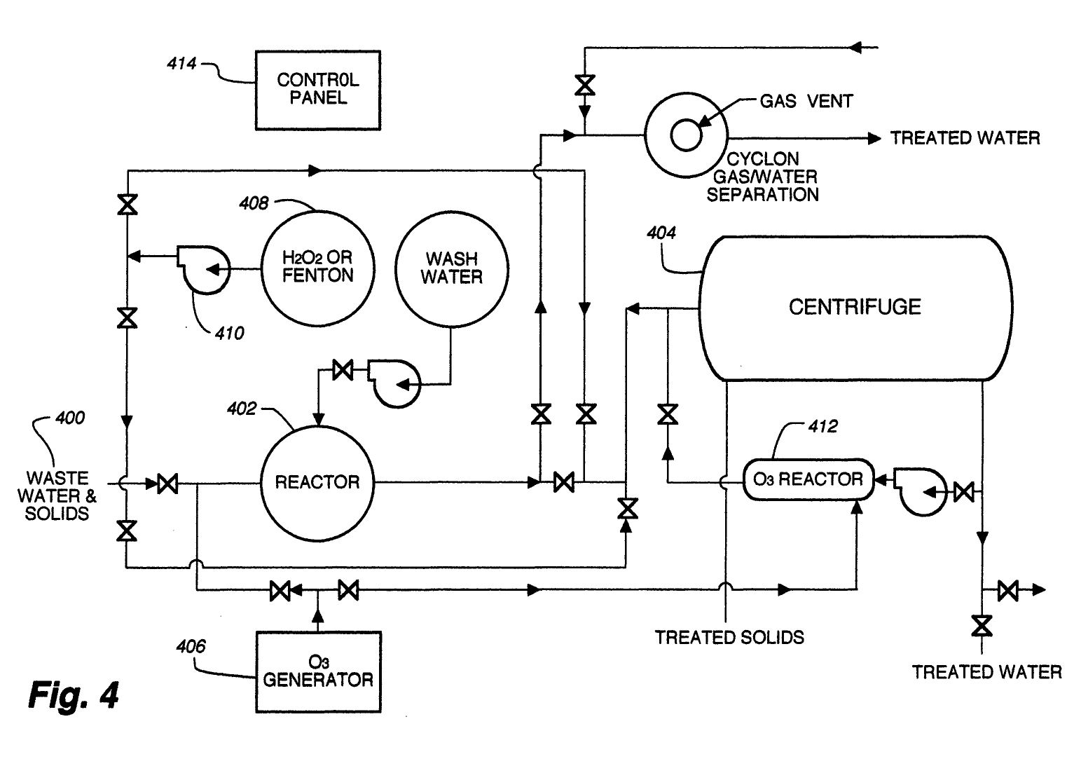

A schematic illustrating various aspects from FIG. 3 is shown in FIG. 4, waste fluid 400 may undergo sub-critical oxidation in a reaction vessel 402 or centrifuge 404. Such sub-critical oxidation may occur in the reaction vessel prior to or subsequent to treatment within the centrifuge. An 03 generator 406 provides ozone for the oxidation reaction; H₂O₂ or other like hydroxyl radical forming material is stored and available for reactions 408 and is distributed by pump 410. An alternative or second reactor for sub-critical oxidation reactions may be included 412. Such secondary reactor is typically smaller is size and could be used for the sub-critical oxidation reactions of the present invention when the contaminate level within a waste fluid is below a pre-determined level. For example, when the contaminate level is below 10 mg/L, the waste fluid would be moved to the secondary reactor and would not be processed within the primary reactor—thereby providing a significant cost benefit to the system. The predetermined threshold contaminate level would be determined by the size of the secondary reactor. A control panel 414 optimizes conditions to achieve predetermined reductions in contaminants within the waste fluid. Note that the system shown in FIG. 4 may be particularly useful in the generation of hydroxyl radicals for use in sub-critical oxidation of contaminates within the waste fluid 400.

One example of the process of the invention occurs within a multiphase centrifuge having long detention time, i.e., one minute or more, such as a decanter centrifuge made by Pieralisi Benelux B.V. (Netherlands) (see 2003 Decanter Centrifuge Brochure for Pieralisi). Another concentric tubular centrifuge such as that disclosed in U.S. Patent Publication U.S. 2002/003211A1 (which is herein incorporated by reference in its entirety) may also be used in this manner. Other continuous flow centrifuges known in the art may be used. In addition, other types of centrifuge devices may be used in the context of the present invention.

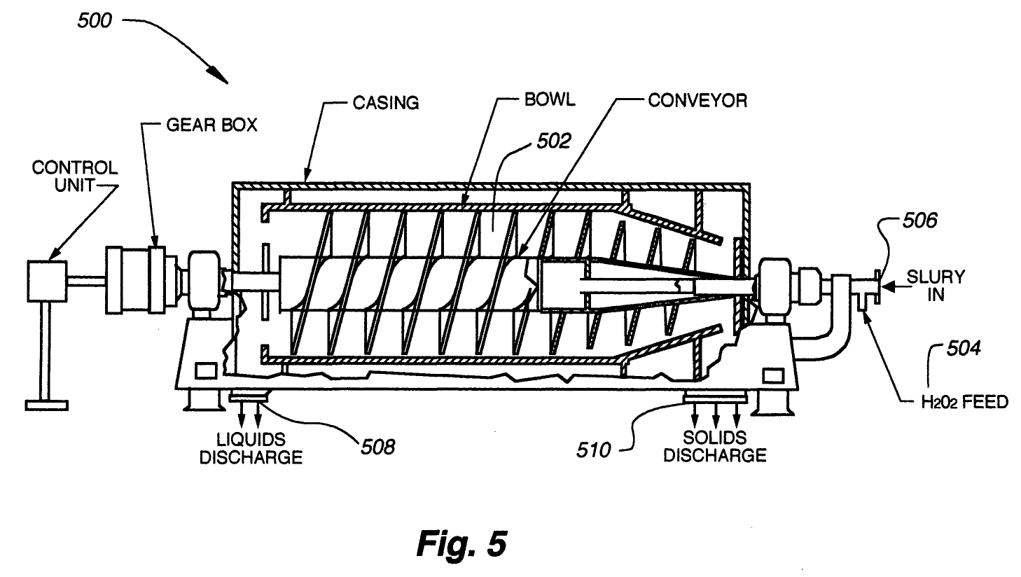

Reference is made to FIG. 5. A typical decanter centrifuge 500 is illustrated. Decanter centrifuges are used for the separation of two or more phases of different specific gravity, and in particular for separating liquids in which suspended solids are present. A cylindrical rotating drum 502 is used for separating solids from liquids and for performing the sub-critical oxidation processes of the present invention. An auger or other like device may be used to remove solid phase materials from the drum.

Prior to entry into a decanter centrifuge, an oxidant such as H₂O₂ is added to the waste fluid 504. This waste fluid enters the centrifuge along its axis of rotation 506. In a preferred embodiment, the centrifuge is at speed to produce the desired sub-critical pressure and heated and/or cooled to a predetermined sub-critical temperature prior to introduction of the initial flow of the waste fluid/H₂O₂ mixture into the centrifuge. Treated waste fluid exits the centrifuge 508. Residual solid material, if present, exits the centrifuge 510 which may be facilitated by way of auger. The residual solid material exits the centrifuge at its base.

Note that the above described continuous flow centrifuge is also relevant for separating solids from liquids or separating multiple fluids having different density characteristics from each other in the absence of an oxidative process.

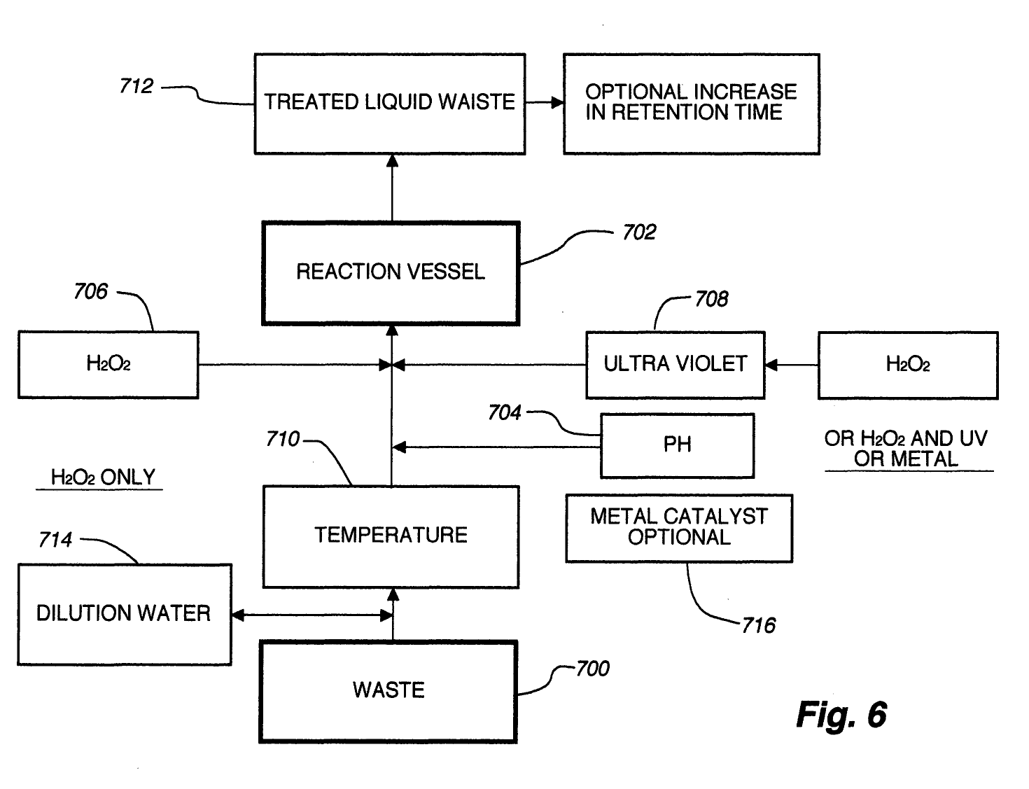

FIG. 6 is a flow diagram of a reaction vessel based process for sub-critical oxidation of a waste fluid 700. Waste fluid is added to the reaction vessel 702. The pH 704 is adjusted if necessary to between 3 and 10 dependent on the reaction conditions. For example, preferred pH conditions for use of the Fenton reagent is about 3 to about 5, for ozone it is about 8 to about 10, and for UV it is about 6 to about 9. Thereafter, an oxidizing agent 706 such as hydrogen peroxide is added to the waste fluid and mixed. In an alternate embodiment, hydrogen peroxide may be treated with ultraviolet light 708 to produce free hydroxyl radicals which are mixed with the waste fluid. Ozone may also be used as an oxidant and in some embodiments oxygen may be used.

After being mixed with an appropriate oxidant, waste fluid temperature increases to a sub-critical temperature 710 due to the heat produced in the oxidation produced upon mixing. Sub-critical pressure is applied to the waste fluid within the reaction vessel. The temperature may be adjusted to maintain it within the range of sub-critical temperature. The sub-critical oxidation occurs within the reaction vessel over a period of time. Solids which have not been oxidized or which may form during the oxidation process remain within the vessel. The treated liquid waste is removed 712. Dilution water 714 may be added to the reaction vessel, as can metal catalyst 716 to facilitate optimal oxidation.

In another aspect, the invention includes a process for hydrolyzing a waste fluid by exposing it to a sub-critical temperature and sub-critical pressure so as to hydrolyze certain constituents of the waste fluid. It is preferred that hydrolysis be carried out in a continuous flow centrifuge system/reactor system as described for sub-critical oxidation. In some instances a chemical reagent may be added to the facilitate the hydrolysis. An example of a chemical reagent is calcium oxide. Other chemical reagents are known to those skilled in the art. Typical hydrolysis reactions include the hydrolysis of cyanide and phosphorus:
CN⁻+2H₂O→NH₃+HCO₂
4P+3CaO+3H₂→O PH₃+3CaHPO₂

Sub-critical hydrolysis may be used alone but is preferably combined with sub-critical oxidation. In this regard, sub-critical hydrolysis may occur prior to or after sub-critical oxidation. In some instances, sub-critical bydrolysis and oxidation occur simultaneously.

In another aspect, the invention includes a sub-critical oxidation process having conditions that utilize hydroxyl radicals. In one embodiment, components of hydroxyl radical formation include contemporaneously combining a waste fluid with hydrogen peroxide and then an agent that reacts to form the hydroxyl radical. Agents that react to form the hydroxyl radical with the hydrogen peroxide containing waste fluid include, but are not limited to, Fenton's reagent, ozone and other like hydroxyl radical forming reagents, for example titanium dioxide (catalytic reaction, see for example, U.S. Pat. No. 6,136,186 which is herein incorporated by reference in its entirety). The mixture may also be exposed to UV radiation to transform hydrogen peroxide to hydroxyl radicals. Enhanced oxidation within the waste fluid occurs when hydroxyl radical is formed in close association to the organic contaminates to allow for the oxidation reaction to proceed (note that oxidation of inorganic contaminates within the waste fluid may also occur in the context of the present invention, although only organics will be specifically called out for the remainder of the disclosure). In preferred embodiments, the oxidation rate of the contaminates is significantly increased.

Typical reactions that favor hydroxyl radical formation, and therefore hydroxyl radical based oxidation within the waste fluid include: H₂O₂+UV→2OH; O₃+H₂O₂→2OH+3O₂; and Fenton's reagent+H₂O₂→OH+OH⁻. Hydroxyl radical formation occurs within the waste fluid and preferably in intimate contact with target organic contaminates.

For purposes of this hydroxyl radical based oxidation embodiment, conditions that favor hydroxyl radical formation and enhanced oxidation includes mass transfer by mixing and flow kinetics, temperatures between about ambient temperature and a temperature below about 200° C. and a pressure between about 1 atmosphere and about 100 psi (note that higher pressures can be used, however little benefit is anticipated for the increased pressure in relation to cost and the solubility of the different reactants; note also that higher temperatures, for example up to 374.1° C. can be used, but has little or no beneficial effect on the reaction). Preferred temperatures are between about ambient temperature and 40° C.

In preferred embodiments, hydrogen peroxide is added to the waste fluid in an amount sufficient to support subsequent hydroxyl radical based oxidation of the organic constituents. The amount of hydrogen peroxide will therefore vary dependent upon reaction conditions, i.e., temperature, pressure, pH, mixing conditions, etc and the amount and type of organic contaminates that are to be oxidized. In this regard, the amount of Fenton's reagent, ozone or UV light is required dependent on the level of hydrogen peroxide added to the reaction. It is envisioned that additional hydrogen peroxide as well as Fenton reagent, ozone, or UV light may be added to the waste fluid during a hydroxyl radical based oxidation reaction, thereby ensuring that the maximum amount of organic contaminate is oxidized during the course of any one particular oxidation reaction.

In preferred embodiments, the hydroxyl based oxidation is performed either using a mixing device and flow kinetics, a centrifuge vessel, or a sequence using a mixing device followed by a centrifuge device.

Mixing devices for use in practicing the present invention include any device that allows diffusion of hydrogen peroxide, ozone and Fenton reagent for the contemporaneous formation of hydroxyl radical and oxidation of organic contaminates in a waste fluid. In one embodiment, the mixing device is a standard cylindrical or other like mixing device with capacity for mixing of reactants and release of evolved product, for example carbon dioxide. A mixing device for use with ozone or other like gaseous material is one which allows for passage of the ozone through the hydrogen peroxide containing waste fluid. The waste fluid and hydrogen peroxide are mixed together while a continuous and substantially uniform flow of ozone is passed through a porous ceramic plug located at or near the bottom of the vessel. In such case, the concentration of the ozone may be modified within the hydrogen peroxide containing waste fluid by increasing or decreasing the flow rate of the ozone. It is also noted that preferred mixing devices have the capacity for both temperature, pressure, and mixing speed modification during the hydroxyl radical formation.

In addition, preferred mixing devices of the invention create smaller diameter ozone bubble sizes, i.e., smaller sizes than previously reported in like technologies, to maximize dissolution of ozone with hydrogen peroxide containing waste fluid. Also, preferred mixing devices are operated under at least one atmosphere pressure so as to keep the dissolved oxygen containing species, including ozone, in solution helping to prevent an increase in bubble size that it is not able to dissipate into the surrounding environment. This is especially true given that oxygen and oxygen containing species tend to be volatile and likely to leave solution under non-pressurized conditions.

Preferred mass transfer devices of the invention that support hydroxyl radical formation through mass transfer diffusion, preferably have capacity to facilitate diffusion of the relevant constituents. For purposes of the invention, intimate mixing refers to the use of a device or method that results in effective concentration of hydroxyl radicals within the waste fluid. Intimate mixing typically entails a thorough mixing of the waste fluid containing hydrogen peroxide with a reagent that facilitates hydroxyl radical formation. When entirely mixed, hydroxyl radicals are formed at a faster rate which in turn results in an increased rate of oxidation of organic and inorganic contaminates as compared to bulk addition to the radical forming reagent. Preferred devices that accomplish intimate mixing are disclosed in U.S. Pat. Nos. 5,200,094, 5,344,573, and 5,403,494 (see, e.g., reference numeral 16 and generally FIG. 6), as well as variations of that same device as disclosed in U.S. Pat. No. 6,361,925.

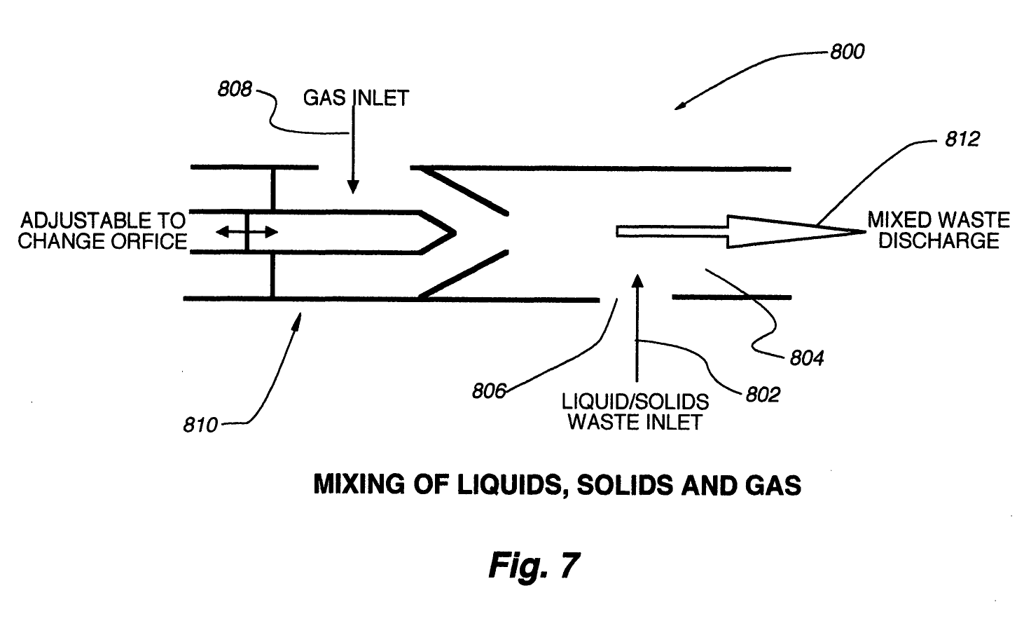

FIG. 7 is a simplified schematic of one embodiment of an intimate mixing device 800. The hydrogen peroxide containing waste fluid (as represented by arrow 802) is passed into a chamber 804 through an opening 806. Hydroxyl radical forming reagent such as ozone or Fenton reagent (as represented by arrow 808) is introduced into chamber 804 via an adjustable orifice 812. Orifice 810 can be modified to allow for maximal intimate mixing between the hydrogen peroxide containing waste fluid 802 and the hydroxyl radical forming agent 808. Treated waste fluid is discharged out of the device in the direction as indicated by arrow 812.

An alternative preferred intimate mixing device is a “fogging device” using a swirl jet nozzle. It is believed that mass transfer mixing techniques under conditions that favor hydroxyl radical formation allow for a considerable decrease in the amount of time required to oxidize the organic contaminates within a waste fluid to completion, i.e., from hours or days to minutes.

There is not one reaction or design that through oxidation destruction of contaminates solve every waste water contamination problem. The selection of chemicals and process design for the oxidation of contaminates must be based on the specific waste water characteristics. With that in consideration, the following preferred embodiments are provided.

In an alternative embodiment, the process of the invention occurs within a mass transfer mixing device adapted for enhancing and optimizing the “mass transfer” of a gaseous reagent (one that facilitates hydroxyl radical formation) into a waste fluid, and preferably into a waste fluid that contains hydrogen peroxide. For example, the mass transfer of ozone into a waste fluid containing hydrogen peroxide. For purposes of the present invention, “mass transfer” refers to the transfer of a gas dissolution to liquid, formation of hydroxyl radical, and reaction of hydroxyl radical with contaminates, and preferably into a waste fluid containing hydrogen peroxide. The liquid waste can have suspended solids.

Processes of the present embodiment facilitate and optimize the mass transfer of a hydroxyl radical forming reagent, e.g., ozone, into a waste fluid. Optimal mass transfer in this context results in facilitating and increasing the rate at which the hydroxyl radical forming reagent enters/transfers into the liquid phase. As such, enhanced mass transfer results in enhanced hydroxyl radical formation in the liquid phrase, which in turn results in an increased rate of oxidation of organic and inorganic contaminates within the waste fluid.

Processes of the invention that facilitate the mass transfer of hydroxyl radical forming reagents into a waste fluid include using small bubble size, for the gas and providing a waste fluid under plug flow (laminar) conditions or thin film flow, for interaction with the gas bubbles.

In one embodiment, the waste fluid is partitioned into thin water units or waste water films, “thin film flow” of waste water, providing small units of turbulent liquid that are easily penetrated via transfer of a gas into the waste fluid. The turbulent flow then creates combination of the hydroxyl radical with the contaminates that further drives the mass transfer of the oxidation reaction of the contaminates. Additionally, processes of the invention provide the waste fluid is moved as a unit with little or no shear—providing optimal units of fluid for mass transfer of the ozone into the liquid phase oxidation reaction of the hydroxyl radical with the contaminate.

In addition, mass transfer in reference to the present invention, is enhanced under conditions that support limiting the escape of the dissolved hydroxyl radical forming reagent from the waste liquid, for example, maintaining the waste fluid under at least one atmosphere of pressure. Other sub-critical oxidation conditions for the process are as described above, especially with reference to pH and temperature.

Mass transfer processes of the present invention provide an environment that allows for substantial increase in destruction of organic and inorganic contaminates within a waste fluid, i.e., levels of up to and exceeding 3,000 mg/L can be destroyed, in a surprisingly short period of time, i.e., minutes instead of hours.

Mass transfer processes of the present invention can be performed in mass transfer reactors adapted to enhance mass transfer of the hydroxyl radical forming reagent into the waste fluid, and preferably into the waste fluid containing hydrogen peroxide. These adapted mixing vessels are termed “mass transfer reactors.” In addition, mass transfer processes of the present invention can be performed in continuous and non-continuous centrifuge vessels that have been adapted to enhance the mass transfer of a gas into a liquid. Finally, mass transfer processes of the present invention can be performed using a sequence of a mass transfer reactor followed by a centrifuge device to remove any non-dissolved solids from the treated waste fluid.

For purposes of the present invention, system embodiments (see FIGS. 1-4) can include a mass transfer reactor. For example, the reaction vessel 402 shown in FIG. 4 can be a mass transfer reactor. Using the systems of the present invention, it is anticipated that destruction of up-to substantially all of an organic or inorganic material in a waste fluid can be achieved.

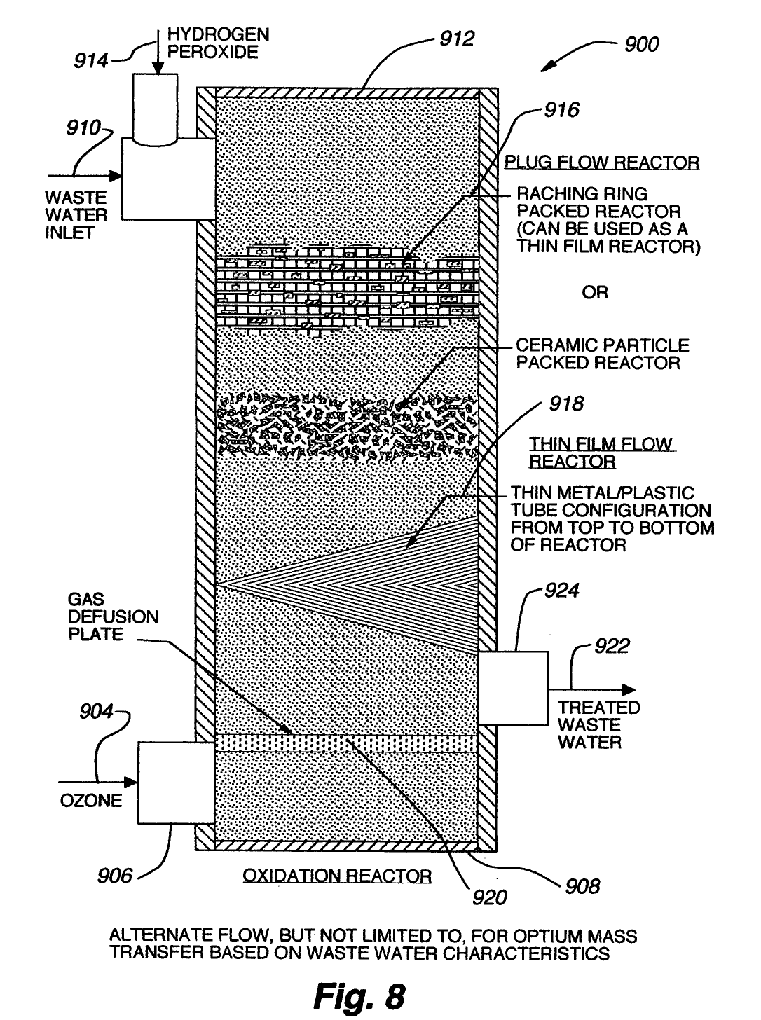

Referring to FIG. 8, an illustrative cross-sectional view of a mass transfer reactor 900 is shown. Note that mass transfer reactors of the present invention are envisioned to incorporate one of two basic design features: (1) plug flow design where waste fluid moves through the reactor as a unit having little or no shear or (2) thin film flow where the waste fluid moves through the reactor having turbulent flow or shear so as to enhance intimate mixing within the reactor. Again referring to FIG. 8, the reactor 900 has a roughly cylindrical shape formed by a container 902 for receiving the reactants of the sub-critical oxidation. Other reactor shapes are within the scope of the present invention, as long as they facilitate mass transfer processes as previously described.

Ozone or other like gas phase hydroxyl radical forming reagent (see arrow 904) enters the reactor 902 via a port 906 at a bottom end 908 of the container. Waste fluid, as shown by arrow 910, enters the reactor at a top end of the reactor 902. Typically, hydrogen peroxide is added to the waste fluid prior to entrance into the reactor, see arrow 914. Waste fluid enters either as plug flow movement 916 within the reactor or as thin film flow 918 within the reactor or as another like continuous flow movement through the reactor. Typically, the waste fluid moves through the reactor via one of the two designed flow patterns toward the ozone input port 906. For purposes of illustration, two different plug flow reactor designs are shown, a raching ring packed column or ceramic particle packed reactor, and one thin film flow reactor is shown having a series of thin metal/plastic tubes configured to move the waste fluid from the second end of the reactor to the first end of the reactor. Ozone, upon entering the reactor container, passes through a gas diffusion plate 920, or other like structure, to break the ozone gas into a series of small bubbles. Mass transfer is then facilitated as the ozone interacts with waste fluid (plug flow or thin film flow) that allows for high levels of transfer or dissolution of the gas into the liquid phase, thereby increasing the levels of hydroxyl radical formed in relation to the contaminates within the waste fluid. Treated waste fluid (shown by arrow 922) exits the reactor 900 via exit port 922.

Also note that pH and temperature within the mass transfer reactor are as described for other sub-critical oxidation reactions described previously.

Note that in preferred embodiments, the reactor is under pressure to maximize the levels and reduce the bubble size of ozone or other like gas within the waste fluid at all times.

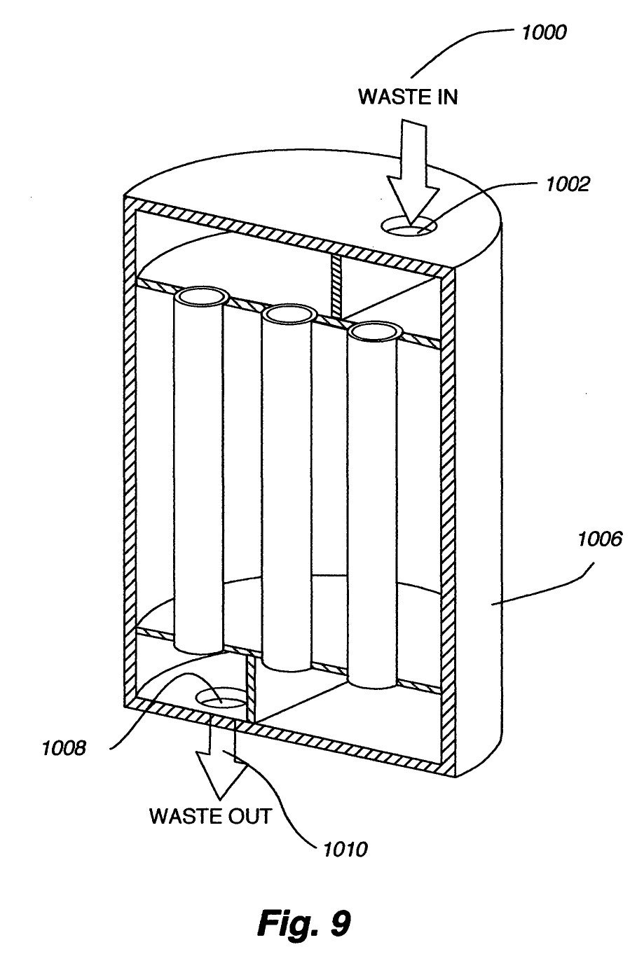

Referring to FIG. 9, an illustrative UV light insert for a reactor, is shown. The UV light insert is shaped to sit within a sub-critical oxidation reactor of the present invention. Preferably, the insert aligns within the reactor, having a similar capacity and shape. Note that in some embodiments, the UV light insert itself can act as a stand alone reactor, thereby not fitting inside a reactor. Regardless, waste fluid, shown as arrow 1000, containing hydrogen peroxide, is received in a first port 1002 for treatment with UV radiation. Fluid flows over UV light sources 1006 to an exit port 1008. Treated waste fluid is shown exiting the UV light insert by arrow 1010. Note that UV radiation is sufficient in energy to transform the hydrogen peroxide to hydroxyl radicals within the insert, which then either partially or completely oxidizes contaminates within the waste fluid. Note that any number of different designs for placement of the UV light source may be used in relation to the present invention, as long as the UV light source provides sufficient energy for the transformation of hydrogen peroxide to hydroxyl radicals.

Preferred centrifuge devices for hydroxyl radical based oxidation are discussed above in relation to sub-critical oxidation. A centrifuge device is required, generally, when some portion of the waste fluid contains a solid component, or when solids are produced via hydroxyl radical based oxidation of the contaminates.

Note also that a waste fluid that has been treated via the hydroxyl radical oxidation methods of the invention, can be tested for contaminates at various time points, and where appropriate re-treated under conditions that favor hydroxyl radical formation, i.e., fresh amounts of hydrogen peroxide added followed by the addition of the Fenton's reagent, ozone, etc. In this manner hydroxyl radical oxidation can be continued until substantially all of the organic contaminates within a waste fluid have been oxidized and consequently broken-down.

It is also noted that an alternative embodiment of the present invention is a process for oxidizing waste fluids using ozone and UV light, in the absence of H₂O₂, under sub-critical temperature and sub-critical pressure. In this embodiment, the ozone is intimately mixed for mass transfer with waste fluid to increase hydroxyl radical formation in relation to contaminates within the fluid. The process would be performed under the same general parameters discussed herein for the combination of hydrogen peroxide containing waste fluid mixed with ozone to increase the rate of hydroxyl radical formation.

The following examples are illustrative in nature and are not meant to limit the scope of the different embodiments of the invention.

### EXAMPLES

### Example 1

### Combination of Hydrogen Peroxide and Ozone in Waste Fluid Partially Reduces the Organic Waste in a Waste Fluid

The following example illustrates the effectiveness of the methods and compositions of the present invention for treating a liquid waste. Note that the present example utilizes sub-critical temperatures and pressures to obtain large decreases in the amount of organic contaminants from a starting waste fluid. Note also that relative to the amount of oxidizing agents used in connection with the present invention, large decreases in organic materials from the waste fluid is achieved. Such dramatic results are attributable to the formation of hydroxyl radicals in waste fluid and that have enhanced reactivity with the organic contaminates in the waste fluid.

Liquid chemical waste obtained from a chemical plant, having approximately 760 mg/L acetone and 2,100 mg/L acetonitrile, was treated with hydrogen peroxide and then ozone added over a period of three hours. Samples were taken every hour to determine concentrations of acetone and acetonitrile over the course of the hydroxyl based oxidation reaction. Results indicated that the combination of ozone and hydrogen peroxide were effective at causing oxidation of acetone and acetonitrile in the waste fluid.

In more detail, tests were initially performed on the untreated waste fluid to ensure that other known organic contaminates were not present, as organic contaminants could interfere with the interpretation of the oxidation data specific for acetone and acetonitrile. Gas chromatography and mass spectrometry confirmed that no other tested organic contaminant (35 were tested) was present in any substantial amount in the waste prior to treatment using the methods and compositions of the present invention (data not shown).

Hydrogen peroxide was added to the chemical waste and allowed to equilibrate. The waste was tested at ambient temperatures at approximately 1 atmosphere of pressure. A flow of ozone was introduced into the bottom of the vessel containing the peroxide treated waste. The ozone entered through a plurality of openings in the bottom of the vessel, thereby increasing the effective concentration of the ozone in relation to the peroxide treated organic contaminants. The pH was maintained throughout the run at between 4 and 8.

As shown in Table 1, compositions and conditions of the present invention are highly effective at oxidizing organic contaminants, e.g., acetone and acetonitrile, in a waste fluid. Under the limited and preliminary design parameters of the present example, approximately 30-50% oxidation was achieved. Based on extrapolation of these results, it is highly likely that a continuous process in accordance with the present invention could achieve almost up to 99+% oxidation in a relatively short amount of time, i.e., even as little as five minutes or less.

TABLE 1
Oxidation of Acetone and Acetonitrile (Partial Reduction)

| | Acetone | Acetonitrile | Oxidation |
|---|---|---|---|
| Sample | (mg/L) | (mg/L) | Time (hrs) |
| Untreated | 760 | 2100 | — |
| Treated | 740 | 2000 | 1 |
| Treated | 470 | 1700 | 2 |
| Treated | 410 | 1500 | 3 |
| Total Oxidation | 46% | 29% | |

The preceding results illustrate the utility of the invention for dramatically decreasing the level of organic contaminants within a liquid waste sample. The results show that temperatures and pressures as low as 3040° C. and 1 atmosphere can be used effectively with hydrogen peroxide and ozone to produce high levels of oxidation of chemical contaminants. These conditions show that conditions that favor hydroxyl radical formation in a waste fluid are very effective for breaking down organic contaminates within the waste fluid.

### Example 2

### Combination of Hydrogen Peroxide and Fenton Reagent Effectively Oxidizes Organic Wastes in a Waste Stream

As was the case in Example 1, the following example illustrates the effectiveness of the methods and compositions of the present invention for treating a waste fluid, especially with respect to conditions that support hydroxyl radical formation. Note that the present example utilizes sub-critical temperatures and pressures to obtain relatively large decreases in the amount of organic contaminants from the start to completion of the reaction(s) within the waste fluid. Note also that relative to the amount of oxidizing agents used in connection with the present invention, large decreases in organic materials from the waste fluid are achieved. This is a result of conditions that enhance and favor hydroxyl radical formation.

Waste fluid streams (one liter) containing hydrogen peroxide (approximately 1,500 mg/L) were treated with Fenton's reagent (approximately 1,000 mg/L Fe(II)) to oxidize hydrocarbons and sulfides. Samples were taken at one, ten, thirty and sixty minutes. Visual inspection of the sample was also noted. An additional 1000 mg/L of Fe(II) was added after the reaction had proceeded for about ninety minutes. The pH of the waste fluid was maintained between 3.5 and 4.5 by addition of 10N NaOH, when the pH began to dip below 3.5, and sulfuric acid was added when the reaction pH exceeded 4.5. Several milliliters of sample were taken of the waste fluid prior to treatment with hydrogen peroxide and Fenton's reagent for analysis via gas chromatography. Several milliliters of the waste fluid were also analyzed by gas chromatography after treatment as described.

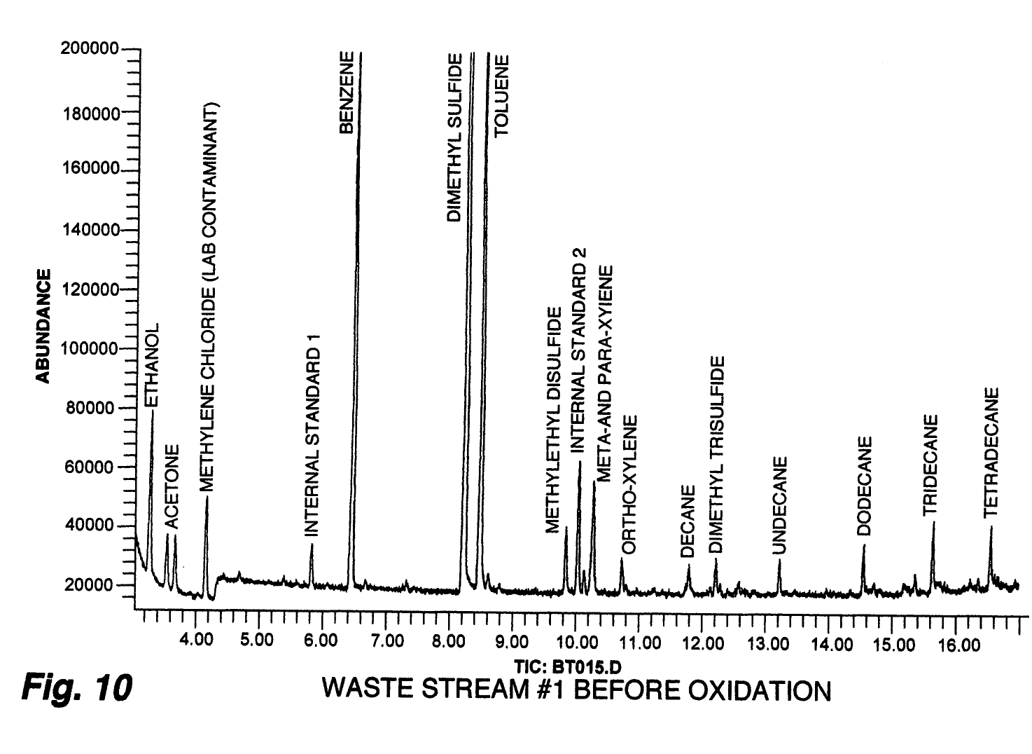

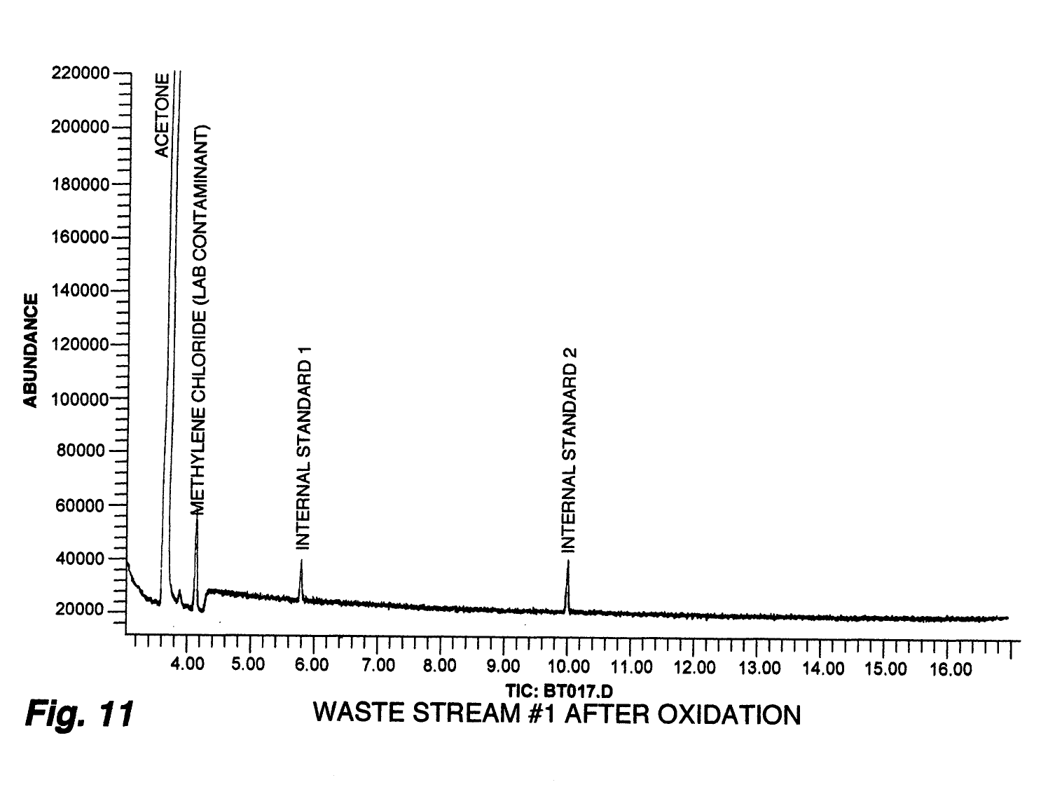

The results indicate that utilization of the Fenton reagent in combination with hydrogen peroxide in a waste fluid achieves excellent oxidation of organic contaminates within a treated waste fluid. As in Example 1, the results support the use of conditions that maximize hydroxyl radical formation for oxidation and break-down (destruction) of organic contaminates within a waste fluid. FIG. 10 illustrates the level of organic contaminates within the waste fluid of Example 2 before treatment. Note that a broad amount of contaminates were present in a range of about 1:100 ppm. As shown in FIG. 11, these organic contaminate levels are significantly decreased using the hydroxyl radical oxidation conditions, in fact, the gas chromatogram shows that substantially 100% of the contaminates were destroyed based on observations. Also based on observation, it appeared that the contaminate destruction occurred within a five to twenty minute time frame.

### Example 3

### Hydrogen Peroxide and Ozone Achieve Total Reduction in Waste Fluid Levels of Acetone and Acetonitrile

The following example illustrates the effectiveness of the methods and compositions of the present invention for treating a liquid waste having high levels of acetone and acetonitrile. As in the previous two examples, the present example utilizes sub-critical temperatures and pressures to obtain near total reduction in the amount of measured contaminates from a starting waste fluid. In addition, the present results support a conclusion that embodiments of the present invention, using continuous flow conditions, would achieve near total oxidation of contaminates within a waste fluid in much faster times than achieved using conventional technologies.

Seven liters of liquid chemical waste was obtained from a chemical plant, the waste having approximately 750 mg/L acetone and 2,100 mg/L acetonitrile. The pH of the waste was maintained at about 7.5 at an ambient temperature. The chemical waste was continuously injected with ozone (see Tables 2 and 3). Due to the limitations in this lab-scale reaction, only a certain amount of ozone could be injected in any given period of time. The known flow of ozone gas was injected into the known volume of waste fluid. The concentration of ozone in the “off” gas was measured. The difference between the input and off gas ozone was the actual ozone consumed in the reactor.

Acetone and acetonitrile within the liquid chemical waste were destroyed by the consumed ozone. A primary design factor for this example was that the amount of ozone consumed in destroying the acetone and acetonitrile was determined to be the amount measured from an initial level, i.e., 750 and 2,100, to a desired or optimal level. Depending on the level of acetone and acetonitrile in the liquid chemical waste, the required amount of ozone was applied to the reactor in a matter of a few minutes or over many hours.

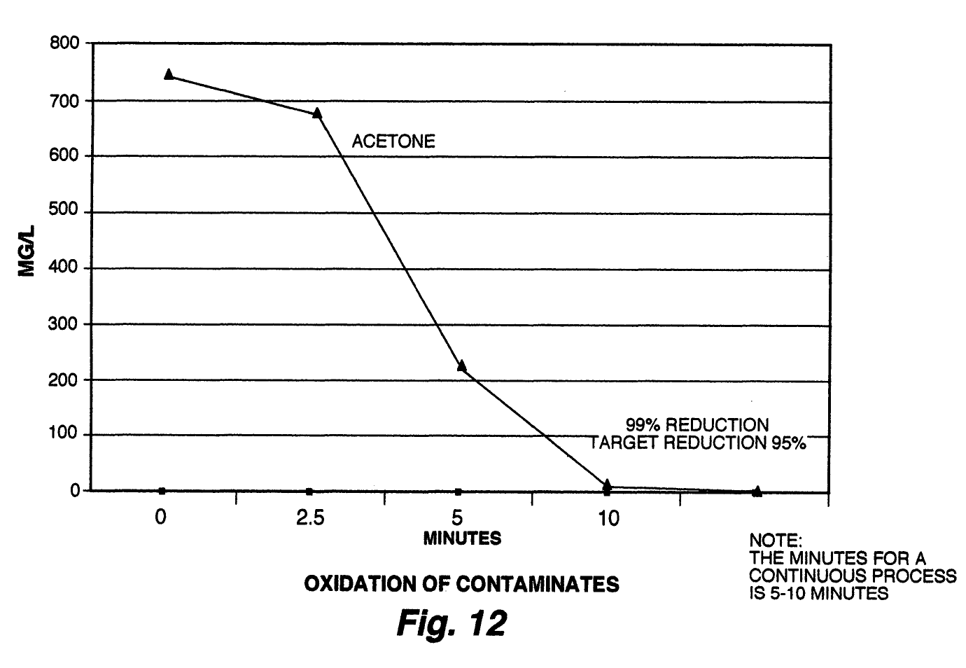

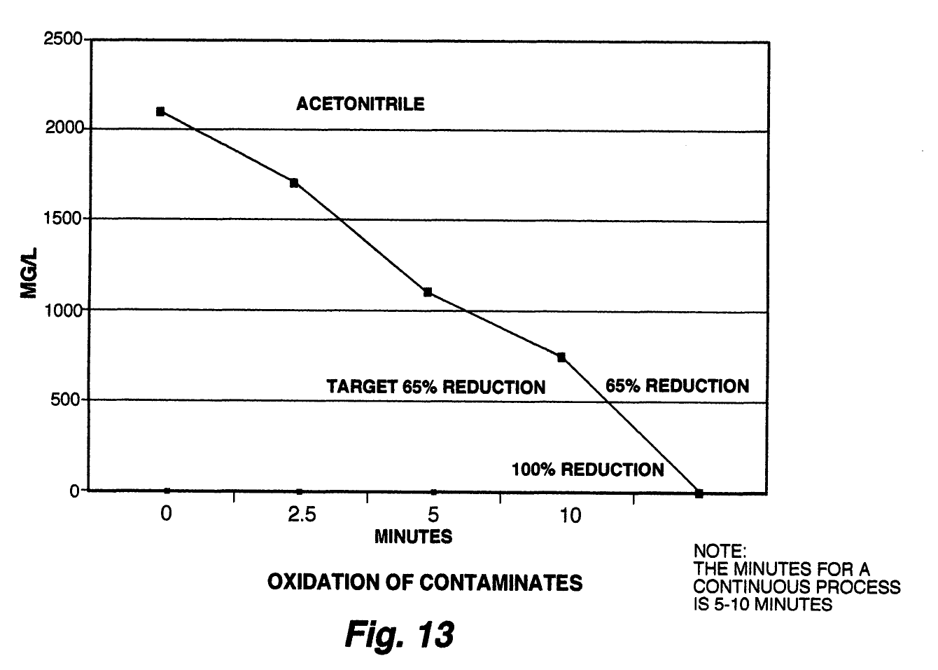

The data in Table 3 shows a compilation of raw data points shown in Table 2. Data from Table 2 is shown as FIGS. 12 and 13. Note that the raw data shown in Table 3 is obtained from a series of four runs under the conditions described above and indicated within the Table 2.

TABLE 2
Raw Data For Oxidation of Acetone and Acetonitrile (Example 3)

| | | Acetone | | Acetonitrile | | COD | | |
|---|---|---|---|---|---|---|---|---|
| Time | Sample | | % | | % | | % | Ozone |
| Minute | point | Level | Red | Level | Red | Level | Red | mg/L |

Run 1

| | | | | | | | | |
|---|---|---|---|---|---|---|---|---|
| 0 | 0 | 750 | | 2100 | | 4144 | | |
| 30 | 1 | | | | | 3992 | 4% | |
| 60 | 2 | 700 | 7% | 2000 | 5% | 3912 | 6% | 465 |
| 90 | 3 | | | | | 3740 | 10% | |
| 120 | 4 | 600 | 20% | 1700 | 19% | 3544 | 14% | 930 |
| 150 | 5 | | | | | 3364 | 19% | |
| 180 | 6 | 510 | 32% | 1500 | 29% | 3156 | 24% | 1395 |

Run 2

| | | | | | | | | |
|---|---|---|---|---|---|---|---|---|
| 0 | 0 | 1300 | | 2400 | | 3632 | | |
| 20 | 1 | | | | | 3820 | −5% | |
| 40 | 2 | | | | | 3580 | 1% | 612 |
| 60 | 3 | | | | | 3364 | 7% | |
| 80 | 4 | | | | | 3224 | 11% | 1224 |
| 100 | 5 | | | | | 3068 | 16% | |
| 120 | 6 | 680 | 48% | 1700 | 29% | 2988 | 18% | 1836 |

Continuation

| | | | | | | | | |
|---|---|---|---|---|---|---|---|---|
| 120 | 0 | 540 | 58% | 1600 | 33% | 3232 | 11% | |
| 140 | 1 | | | | | 3008 | 17% | |
| 160 | 2 | 460 | 65% | 1600 | 33% | 2876 | 21% | 2448 |
| 180 | 3 | | | | | 2736 | 25% | |
| 200 | 4 | 320 | 75% | 1300 | 46% | 2508 | 31% | 3060 |
| 220 | 5 | | | | | 2364 | 35% | |
| 240 | 6 | 170 | 87% | 1200 | 50% | 2220 | 39% | 3672 |

Run 3

| | | | | | | | | |
|---|---|---|---|---|---|---|---|---|
| 0 | 0 | 950 | | 1300 | | 4148 | | |
| 240 | 1 | 230 | 76% | 1100 | 15% | 2644 | 36% | 4200 |
| 360 | 2 | 81 | 91% | 880 | 32% | 1864 | 55% | 6300 |
| 420 | 3 | 35 | 96% | 800 | 38% | 1616 | 61% | 7350 |
| 480 | 4 | 13 | 99% | 730 | 44% | 1352 | 67% | 8400 |

Run 4

| | | | | | | |
|---|---|---|---|---|---|---|
| 480 | 0 | 530 | | 968 | | 8400 |
| 540 | 1 | 410 | 68% | 686 | 83% | 10050 |
| 600 | 2 | 250 | 81% | 448 | 89% | 11700 |
| 660 | 3 | 150 | 88% | 284 | 93% | 13350 |
| 720 | 4 | 27 | 98% | 110 | 97% | 15000 |

Note that the bolded data points show selected data used to prepare FIGS. 12 and 13, also see Table 3

TABLE 3
Oxidation of Acetone and Acetonitrile (Example 3)

| | Acetone | Acetonitrile | Time | Ozone |
|---|---|---|---|---|
| Sample | (mg/L) | (mg/L) | (minutes) | (mg/L) |
| Untreated | 750 | 2,100 | — | — |
| Liquid | | | | |
| Chemical | | | | |
| Waste | | | | |
| Treated | 680 | 1,700 | 120 | 1,836 |
| Treated | 230 | 1,100 | 240 | 4,200 |
| Treated | 13 | 730 | 480 | 8,400 |
| Treated | — | 27 | 720 | 15,000 |

An analysis of the data shown in Table 3 was used to convert this “batch data” to data illustrating how long it would take to accomplish the same results using a continuous flow system. The contaminate (mg/L) data shown in Table 3 was then plotted against actual batch time to determine consistency of the reaction, i.e., whether the test results were essentially linear. Test plots indicated that the data for acetone and acetonitrile had linear slopes, thereby allowing for the conversion to continuous results as follows: first an arbitrary amount of time was allotted for the destruction of acetone and acetonitrile using a continuous flow design; dividing the batch measured contaminate levels by batch measured minutes for each point of test data; determining whether this number is consistent for all the data in Table 3, which is was, i.e., 680 mg/L/120 minutes=48, etc; multiplying the batch volume for the measured data, e.g., 7 L, by the constant 48 to determine how much volume could be treated using the same experimental set-up but for a continuous flow, i.e., 7 L×48=336 L. Therefore, the test data from Example 3 supports a finding that a continuous flow reactor could treat 336 L of liquid in about 15 minutes of time (compare this result with the amount of time required to generate the data in a batch fashion, ˜480 minutes to treat 7 L). Also note that test results shown in this Example were performed by Hydroxyl Systems Inc., Sidney BC V8L 5W5, Canada.

This Example illustrates that high levels of dissolved acetone and acetonitrile in a liquid chemical waste can be destroyed in less than an hour and often within 3-15 minutes. This data clearly demonstrates that the methods and compositions of the present invention provide a vast improvement for the oxidation of contaminates over other conventional technologies which take hours to oxidize much smaller amounts of contaminates, i.e., the inventors are not aware of prior art references showing oxidation treatment of above 1-100 mg/L.

Various modifications, equivalent processes, as well as numerous structures to which the present invention may be applicable will be readily apparent to those of skill in the art to the present invention is directed upon review of the disclosure. All references, including patents and patent applications, referred to within the present disclosure are incorporated by reference in their entirety.

This specification contains numerous citations to patents, patent applications and publications. Each is hereby incorporated by reference for all purposes.

1. A process for treating waste fluid and gases comprising mixing hydrogen peroxide with said waste fluid to form a mixture, contacting said mixture with a hydroxyl radical forming reagent, kinetic flow for mass transfer of the hydroxyl radical formation for oxidation of contaminates at a sub-critical temperature between ambient temperature and a temperature less than 374.1° C. and a sub-critical pressure between about 1 atmosphere and a pressure less that 3208 psi, wherein all or a part of the waste material in said waste fluid is oxidized to form a treated waste fluid and, if present, a residual solid.

2. The process of claim 1 wherein said sub-critical temperature is between 30° C. and 100° C. and said sub-critical pressure is between 1 atmosphere and 100 psi.

3. The process of claim 1 wherein said hydroxyl radical forming reagent comprises ozone.

4. The process of claim 1 wherein said sub-critical temperature and pressure is generated within a centrifuge.

5. The process of claim 4 wherein said centrifuge comprises a continuous flow centrifuge wherein said mixture flows continuously into and out of said centrifuge, wherein, if present, said solid residue and oxidized solid residue portions are precipitated and separately removed from said centrifuge and wherein said mass transfer occurs within said centrifuge.

6. The process of claim 1 wherein said sub-critical temperature and pressure is generated within a reactor.

7. The process of claim 6 wherein said reactor allows for continuous passage of a gaseous material through said waste fluid.

8. The process of claim 6 wherein said reactor facilitates enhanced mass transfer in terms of diffusion of said waste fluid with said hydroxyl radical forming reagent.

9. The process of claim 8 wherein said reactor is a thin film mass transfer reactor.

10. A process for treating a waste fluid comprising mixing hydrogen peroxide with said waste fluid to form a mixture; controlling the temperature and pressure of said mixture to a sub-critical temperature between ambient temperature and a temperature less than 200° C. and a sub-critical pressure between about 1 atmosphere and a pressure less than 100 psi and exposing said mixture to UV having sufficient energy to form hydroxyl radicals from said hydrogen peroxide, wherein all or a part of the waste material in said waste fluid is oxidized to form a treated waste fluid and, if present, a residual solid.

11. The process of claim 10 wherein said sub-critical temperature and pressure is provided within a centrifuge.

12. The process of claim 11 wherein said centrifuge comprises a continuous flow centrifuge, said waste fluid flows continuously into and out of said centrifuge, wherein, if present, said solid residue portion are separately removed from said centrifuge.

13. The process of claim 10 wherein said sub-critical temperature and pressure is generated within a reactor.

14. The process of claim 13 wherein said reactor further comprises a UV light insert for exposing said mixture to UV having sufficient energy to form hydroxyl radicals from said hydrogen peroxide.

15. A system for oxidizing waste material within a waste fluid comprising:
a hydrogen peroxide dispenser for storing and dispensing hydrogen peroxide into the waste fluid;
an ozone generator for generating ozone and adapted to provide ozone into the waste fluid;
a reactor for treatment of the waste material in a waste fluid wherein the reactor is adapted to promote oxidation of the waste material by mass transfer consisting of diffusion (mixing) and flow kinetics (plug flow and thin film flow); and
a centrifuge for receiving the waste fluid either before or after receipt by the reactor wherein the centrifuge is adapted to promote the removal of particulates within the waste fluid.

16. The system of claim 15 wherein the centrifuge receives the waste fluid after treatment of the waste fluid in the reactor.

17. The system of claim 15 further comprising a dispenser for storing and dispensing a hydroxyl radical forming reagent.

18. The system of claim 15 wherein the reactor is further adapted to provide intimate mixing of the ozone with the waste fluid and hydrogen peroxide mixture.

19. The system of claim 15 further comprising a UV light source for insertion into the reactor, the UV light source adapted to provide sufficient radiation for transforming the hydrogen peroxide into hydroxyl radicals.

20. The system of claim 15 further comprising a control panel adapted to monitor and control the oxidation of the waste material within the waste fluid, wherein the control panel controls the sub-critical pressure and temperature within the reactor.
